(19) United States
(12) Patent Application Publication
(10) Pub. No.: US 2011/0021694 A1
(43) Pub. Date: Jan. 27, 2011

(54) POLYESTERURETHANE FOR COATING COMPOSITIONS

(75) Inventor: DELSON JAYME TRINDADE, ROCHESTER HILLS, MI (US)

Correspondence Address: E I DU PONT DE NEMOURS AND COMPANY;LEGAL PATENT RECORDS CENTER, BARLEY MILL PLAZA 25/1122B, 4417 LANCASTER PIKE, WILMINGTON, DE, 19805, US

(73) Assignee: E.I. DU PONT DE NEMOURS AND COMPANY, Wilmington, DE (US)

(21) Appl. No.: 12/828,331

(22) Filed: Jul. 1, 2010

Related U.S. Application Data
(60) Provisional application No. 61/227,944, filed on Jul. 23, 2009.
(60) Provisional application No. 61/227,955, filed on Jul. 23, 2009.
(60) Provisional application No. 61/227,960, filed on Jul. 23, 2009.

(51) Int. Cl. C08L 75/06; C08G 18/72

(52) U.S. Cl. 524/590; 528/60; 528/65

(57) ABSTRACT

This present disclosure relates to a polyesterurethane and to coating compositions comprising the polyesterurethane as the crosslinkable component that are especially useful as automotive clearcoats that are very resistant to environmental etch damage. The polyesterurethane is the reaction product of reaction product of a hydroxyl functional branched polyester prepolymer with an isocyanate functional compound and the branched polyester prepolymer is the reaction product of one or more monofunctional carboxylic acid monomers, one or more hydroxyl functional monomers having a hydroxyl functionality of 3 to 10 and one or more polycarboxylic acid monomers.

### CROSS-REFERENCE TO RELATED APPLICATION

This application claims priority under 35 U.S.C. §119 from U.S. Provisional Application Ser. No. 61/227,944, filed Jul. 23, 2009, U.S. Provisional Application Ser. No. 61/227,955, filed Jul. 23, 2009 and U.S. Provisional Application Ser. No. 61/227,960, filed Jul. 23, 2009.

### FIELD OF THE DISCLOSURE

This present disclosure relates to a polyesterurethane and to coating compositions comprising the polyesterurethane as the crosslinkable component that are especially useful as automotive clearcoats. The present disclosure also relates to substrates coated with a clearcoat comprising the polyesterurethane. Dried and cured clearcoats containing the disclosed poyesterurethane are very resistant to environmental etch damage.

### DESCRIPTION OF THE RELATED ART

In the field of automotive coatings, vehicles are typically painted with several layers of coatings to provide an attractive, durable and corrosion resistant finish. In most automotive coating procedures, a cathodic electrocoat layer is applied and baked to provide a corrosion resistant layer over the metal substrate. A primer layer can be applied over the electrocoat layer to help to provide a smooth chip resistant layer. In general, the applied primer layer is then baked to provide a dry crosslinked coating. The color-providing layer, called a basecoat layer, can then be applied over the primer layer. A layer of a protective clearcoat is then applied over the layer of basecoat composition prior to the basecoat being fully dried and/or crosslinked. This is called a wet-on-wet application. After the application of the clearcoat composition, the composite layers are dried and baked to provide a finish having the aforementioned properties. One or more of each of the described layers may be applied during the finishing of a vehicle.

The clearcoat can be subject to several types of damage due to the action of the environment from, for example, acid rain and mechanical damage, such as small scratches due to washing of the vehicle. These types of damage are usually visible in a finish as very small scratches that can cause a dulling of the glossy appearance of a vehicle. Much research has been devoted toward finding a clearcoat composition that can resist the etching that occurs on a clearcoated surface. Several types of coatings have been developed to combat etching, for example, epoxy acid clearcoats and carbamate functional acrylic clearcoats.

The epoxy acid clearcoat is a coating composition that crosslinks due to the reaction of epoxy functional groups and acid functional groups and is very resistant to environmental etching caused by acid rain. However, epoxy acid clearcoats tend to be susceptible to premature crosslinking which limits their shelf-life.

Carbamate-functional polymers and melamine crosslinking agents are desirable as automotive topcoats because they have excellent durability, hardness, gloss, appearance, and resistance to environmental etch. As such, they can be highly suitable for use as a clearcoat layer applied over a basecoat layer such as those that are extensively used during the manufacturing of an automobile.

However, the use of carbamate-functional acrylic polymers with melamines as cross-linkers can be an issue when used as a clearcoat over waterborne basecoats. Waterborne basecoats are often carboxylic acid functional resins and can contain amines that are used to disperse the resin into water. During baking, the amine can be volatilized from the basecoat and travel through the clearcoat to the surface, where it can be released into the atmosphere. The concentration of amine at the bottom of the clearcoat can be greater than the concentration at the top, which can cause a pH gradient in the clearcoat. Because the rate of curing is a function of the pH, a so-called cure gradient forms in the clearcoat. This leads to an appearance defect known as wrinkling.

Another problem associated with curable coating compositions based on polymers containing pendant carbamate groups and melamine curing agents is that the compositions do not have particularly good intercoat adhesion. This problem presents itself when the compositions are used as clearcoats in a basecoat/clearcoat paint system, especially during repair procedures which involve applying a repair clearcoating composition to a flawed area of a previously applied basecoat/clearcoat system.

It is an object of the present disclosure to produce a clearcoat composition that is resistance to etching and to have excellent intercoat adhesion.

### SUMMARY OF THE DISCLOSURE

The present disclosure relates to a polyesterurethane comprising the reaction product of a hydroxyl functional branched polyester prepolymer and an isocyanate functional compound wherein;
(A) said hydroxyl functional branched polyester prepolymer consists essentially of the reaction product of;
   (I) in the range of from 20 to 80 percent by weight of one or more monofunctional carboxylic acid monomers represented by the formula:

R—COOH
wherein R is an alkyl group comprising in the range of from 7 to 17 carbon atoms;
   (II) in the range of from 10 to 40 percent by weight of one or more hydroxyl functional monomers having a hydroxyl functionality of 3 to 10; and
   (III) in the range of from 10 to 40 percent by weight of one or more polycarboxylic acid monomers; and
(B) said isocyanate functional compound has, on average, at least 2 isocyanate functional groups per molecule; and wherein said percent by weight are based on the total weight of the monomers of the hydroxyl functional branched polyester prepolymer.

The present disclosure also relates to a coating composition comprising the polyesterurethane and to substrate coated by the coating compositions.

### DETAILED DESCRIPTION

As used herein, the phrase “isocyanate functional compound” means a compound, oligomer or polymer having isocyanate functionality.

The term “polycarboxylic acid monomer” means a compound, oligomer or polymer having in the range of from 2 to 10 carboxylic acid groups and/or having at least one anhydride functional group. Combinations of compounds, oligomers and polymers having 2 to 10 carboxylic acid groups and/or anhydride groups are also to be included in this definition.

“Two-pack coating composition” means a curable coating composition having two components stored in separate containers. The containers containing the two components are typically sealed to increase the shelf life of the components of the coating composition. One component of the two-pack coating composition comprises a crosslinkable component and the other component comprises a crosslinking component. These components are mixed prior to use to form a pot mix. The pot life of a pot mix is limited, typically a few minutes (10 minutes to 45 minutes) to a few hours (4 hours to 24 hours). The pot mix can be applied as a layer of a desired thickness on a substrate surface, such as an auto body. After application, the layer dries and cures at ambient or elevated temperatures to form a coating on the substrate surface having desired coating properties.

“One-pack coating composition” means a curable coating composition having both the crosslinkable component and the crosslinking component stored together in one pack. The crosslinking component of this composition can be selected from the group consisting of blocked polyisocyanates, melamines and a combination thereof. One-pack coating compositions are applied to a suitable substrate and are cured at elevated temperatures to form a durable coating.

The features and advantages of the present disclosure will be more readily understood, by those of ordinary skill in the art, from reading the following detailed description. It is to be appreciated that certain embodiments, which are, for clarity, described above and below in the context of separate embodiments, may also be provided in combination in a single embodiment. Conversely, various features that are, for brevity, described in the context of a single embodiment, may also be provided separately or in any sub-combination.

Also, use of “a” or “an” are employed to describe elements and components described herein. This is done merely for convenience and to give a general sense of the scope of the disclosure. This description should be read to include one or at least one and the singular also includes the plural unless the context specifically states otherwise.

The use of numerical values in the various ranges specified in this application, unless expressly indicated otherwise, are stated as approximations as though the minimum and maximum values within the stated ranges were both preceded by the word “about”. In this manner, slight variations above and below the stated ranges can be used to achieve substantially the same results as values within the ranges. Also, the disclosure of these ranges is intended as a continuous range including every value between the minimum and maximum values.

In the foregoing description, the concepts have been described with reference to specific embodiments. However, one of ordinary skill in the art would appreciate that various modifications and changes can be made without departing from the scope of the disclosure as set forth in the claims below. Accordingly, the specification is to be regarded in an illustrative rather than a restrictive sense, and all such modifications are intended to be included within the scope of disclosure.

In one embodiment, a polyesterurethane is described that can comprise or consist essentially of the reaction product of a hydroxyl functional branched polyester prepolymer with an isocyanate functional compound.

In another embodiment, the polyesterurethane comprises or consists essentially of the reaction product of a hydroxyl functional branched polyester prepolymer with a polyisocyanate functional compound.

In other embodiments, the present disclosure relates to a coating composition comprising a crosslinkable and a crosslinking component, wherein the crosslinkable component comprises or consists essentially of the disclosed polyesterurethane.

In further embodiments, the present disclosure relates to a substrate coated with a layer of a dried and cured coating composition wherein the coating composition comprises a crosslinkable and a crosslinking component, and wherein the crosslinkable component comprises or consists essentially of the disclosed polyesterurethane.

In some embodiments, the polyesterurethane comprises the reaction product of a hydroxyl functional branched polyester prepolymer and an isocyanate functional compound, wherein the hydroxyl functional branched polyester prepolymer comprises or consists essentially of the reaction product of;
(I) in the range of from 20 to 80 percent by weight of a one or more monofunctional carboxylic acid monomers represented by the formula: R—COOH; wherein R is an alkyl group comprising in the range of from 7 to 17 carbon atoms;
(II) in the range of from 10 to 40 percent by weight of one or more hydroxyl functional monomers having a hydroxyl functionality of 3 to 10; and
(III) in the range of from 10 to 40 percent by weight of one or more polycarboxylic acid monomers.

All percentages by weight are based upon the total weight of monomers in the hydroxyl functional branched polyester prepolymer.

In other embodiments, the hydroxyl functional branched polyester prepolymer comprises or consists essentially of the reaction product of;
(I) in the range of from 35 to 60 percent by weight of one or more monofunctional carboxylic acid monomers represented by the formula: R—COOH; wherein R is an alkyl group comprising in the range of from 7 to 17 carbon atoms;
(II) in the range of from 20 to 35 percent by weight of one or more hydroxyl functional monomers having a hydroxyl functionality of 3 to 10; and
(III) in the range of from 20 to 30 percent by weight of one or more polycarboxylic acid monomers.

All percentages by weight are based upon the total amount of monomers in the hydroxyl functional branched polyester prepolymer.

The monofunctional carboxylic acid monomer can be represented by the formula; R—COOH, wherein R can be a linear alkyl group, a branched alkyl group or R can comprise a cyclic alkyl group; wherein the alkyl group comprises in the range of from 7 to 17 carbon atoms. Suitable examples of the monofunctional carboxylic acid monomers include, for example, isononanoic acid, oleic acid, decanoic acid, 2-cyclohexyl acetic acid, 2,2-dimethyl pentanoic acid, methyl cyclohexanoic acid, octanoic acid, nonanoic acid or a combination thereof. Ester derivatives of any of the previously mention monofunctional carboxylic acid can be utilized to form the branched polyester prepolymer.

In some embodiments, the monofunctional carboxylic acid can be free from or essentially free from other functional groups that are capable of polymerization by condensation reactions. For example, the monofunctional carboxylic acid can be free from or essentially free from hydroxyl groups or amine functional groups. As used herein, the phrase ‘essentially free from’ means containing less 1 percent by weight. Thus, a monofunctional carboxylic acid monomer is essentially free from hydroxyl functional groups provided that less than 1 percent by weight of said monomers have a hydroxyl functional group.

The branched polyester prepolymer can be formed from one or more hydroxyl functional monomers having, on average, 3 to 10 hydroxyl groups per molecule. Suitable hydroxyl functional monomers include, for example, trimethylol propane, trimethylol ethane, pentaerythritol, glycerol, ditrimethylol propane, dipentaerythritol, tetrakis (2-hydroxyethyl)methane, diglycerol, xylitol, sorbitol, sucrose or a combination thereof.

The third component that can be used to form the branched polyester prepolymer is a polycarboxylic acid monomer or an ester derivative thereof. As used herein, the term “polycarboxylic acid monomer” is meant to encompass a molecule that has in the range of from 2 to 10 carboxylic acid functional groups per molecule and/or 1 to 5 anhydride functional groups per molecule. In some embodiments, the polycarboxylic acid can be a dicarboxylic acid. In more specific embodiments, the polycarboxylic acid monomers can be chosen from the group consisting of hexahydrophthalic anhydride, methyl hexahydrophthalic anhydride, alkyl hexahydrophthalic anhydride, maleic acid, fumaric acid, succinic acid, hexahydrophthalic acid, alkyl hexahydrophthalic acid, tetrahydrophthalic acid, alkyl tetrahydrophthalic acid, adipic acid, glutaric acid, malonic acid, azelaic acid, sebacic acid, dodecanoic acid, maleic anhydride, succinic anhydride, tetrahydrophthalic anhydride, methyl tetrahydrophthalic anhydride, alkyl tetrahydrophthalic anhydrides, adipic anhydride, glutaric anhydride or a combination thereof.

To produce the hydroxyl functional branched polyester prepolymer, any of the known polyester formation procedures can be utilized. In one embodiment, the monofunctional carboxylic acid monomer, the hydroxyl functional monomer and the polycarboxylic acid can be mixed and heated until the desired branched polyester prepolymer is formed. In another embodiment, the branched polyester prepolymer can be produced in a step-wise fashion, by first forming a hydroxyl functional polyester intermediate, which comprises reacting the hydroxyl functional monomer with the monofunctional carboxylic acid. In a second step, this intermediate product can be reacted with the polycarboxylic acid monomer until the desired product is formed.

In a third embodiment, the hydroxyl functional monomer can be reacted with the polycarboxylic acid monomer to form an intermediate reaction product. This intermediate reaction product can then be capped with the monofunctional carboxylic acid to form the desired hydroxyl functional branched polyester prepolymer.

Solvents and catalysts typically used for polyester condensation reactions are optional when forming the hydroxyl functional branched polyester prepolymer.

In some embodiments, the hydroxyl number of the branched polyester prepolymer can be in the range of from 150 to 300 mg KOH/g product and the acid number can be in the range of from 1 to 40 mg KOH/g product and that the branched polyester prepolymer can have a weight average molecular weight in the range of from 1,000 to 100,000.

In some embodiments, the desired polyesterurethane can be formed by reacting the hydroxyl functional branched polyester prepolymer with an isocyanate functional compound having in the range of from 2 to 10 isocyanate functional groups per molecule. In some embodiments, the isocyanate:hydroxyl group ratio can be in the range of from 1:20 to 1:2. In other embodiments, the isocyanate:hydroxyl group ratio can be in the range of from 1:10 to 1:5.

If desired, the isocyanate functional compound can optionally have, in addition to the free isocyanate functional groups, 1 to 4 isocyanate functional groups per molecule that are blocked by one of the known isocyanate blocking groups.

In some embodiments, the isocyanate functional compounds are aliphatic polyisocyanate functional compounds. In more specific embodiments, the polyisocyanate compounds can include 1,2-propane diisocyanate, 1,3-propane diisocyanate, 1,4-butane diisocyanate, 2,3-butane diisocyanate, 1,3-cyclopentane diisocyanate, 1,4-cyclohexane diisocyanate, 1,3-cyclohexane diisocyanate, 1,6-hexamethylene diisocyanate, isophorone diisocyanate, bis(1,4-isocyanatomethyl)cyclohexane, bis(1,3-isocyanatomethyl)cyclohexane, or a combination thereof.

Isocyanate functional derivatives of any of the above listed polyisocyanates can be used as well. These can include, for example, isocyanates containing isocyanurate, allophonate, and/or biuret groups. Other derivatives can include, for example, isocyanate functional reaction products of polyols and or polyamines with an excess of any of the previously mentioned polyisocyanates.

Structure (I) is shown as an example of one possible structure of the polyesterurethane;

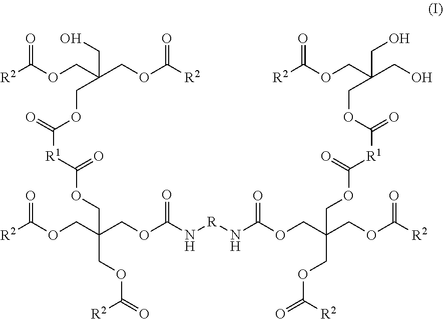

wherein R is derived from the isocyanate functional compound; R¹ is derived from the polycarboxylic acid monomer; and R² is derived from the monocarboxylic acid. In the above idealized structure, 4 moles of pentaerythritol, 2 moles of a diacid or anhydride, and 7 moles of a monoacid were reacted to give a branched polyester prepolymer which was then reacted with 1 mole of a diisocyanate to provide the polyesterurethane. The structure as denoted by structure (I) is meant to be a representative embodiment of one possible structure and is not to be construed as limiting the scope in any way. While this structure is possible, it is but one of many different combinations that can result from the given stoichiometric ratio.

The disclosed polyesterurethane can be used as the crosslinkable component in a coating composition, especially in an automotive clearcoat composition. The polyesterurethane can be used as the only crosslinkable component or can be used in combination with other known crosslinkable components. Together, the crosslinkable and crosslinking component comprise the film forming binder. In some embodiments, the disclosed polyesterurethane can comprise in the range of from 10 percent to 100 percent by weight of the crosslinkable component. In other embodiments, the polyesterurethane can comprise in the range of from 25 percent to 90 percent by weight of the crosslinkable component.

Other crosslinkable components are known in the art and can include, for example, acrylic polymers, polyester polymers, polyurethane polymers, silane resin, alkyd polymers and combinations thereof. In some embodiments, the other crosslinkable components comprise crosslinkable functional groups that are capable of reacting with the crosslinking component to form a crosslinked coating. Suitable crosslinkable functional groups can include, for example, hydroxyl groups, silane groups, amine groups, carboxylic acid groups or a combination thereof.

The coating composition can also comprise as part of the film-forming binder, one or more crosslinking components. In some embodiments, the crosslinking component can be chosen from melamine resins, polyisocyanates, blocked polyisocyanates or a combination thereof. Suitable melamine resins can be monomeric or polymeric melamines or a combination thereof. Suitable melamines include, for example, methylated, butylated, isobutylated melamines and mixtures thereof. In some embodiments, the crosslinking component can include, for example, hexamethylol melamine, trimethylol melamine, partially methylated hexamethylol melamine or a combination thereof. In other embodiments the crosslinking component can be chosen from, hexamethylol melamine, partially methylated hexamethylol melamine or a combination thereof.

Suitable polyisocyanates can include any of those mentioned for the production for the polyesterurethane. Blocked polyisocyanates are also known and can be used as the crosslinking component. Blocking agents are well known in the art and can include, for example, phenols, lactams, alcohols, active methylene compounds, alcohols, mercaptans, acid amides, imides, amines, imidazoles, ureas, carbamates, oximes, pyrazoles, ketoximes, triazoles or a combination thereof.

In some embodiments, the weight ratio of crosslinkable component to crosslinking component can be in the range of from 10:1 to 1:10. In other embodiments, the weight ratio of crosslinkable component to crosslinking component can be in the range of from 7:1 to 1:7. In still further embodiments, the weight ratio of crosslinkable component to crosslinking component can be in the range of from 5:1 to 1:5.

The coating composition can include one or more catalysts to enhance crosslinking of the components on curing. Some suitable catalysts can include dialkyl tin diesters; aromatic acid catalysts, such as, for example, dodecylbenzene sulfonic acid, para-toluenesulfonic acid, dinonylnaphthalene sulfonic acid, phosphoric acids, phenyl acid phosphate or a combination thereof. The acid catalysts can be free acids or they can be blocked with an amine, such as, for example, diisopropanolamine, dimethyl oxazolidine, 2-amino-2-methyl-1-propanol or a combination thereof.

In some embodiments, the coating composition can include one or more catalyst in the range of from 0.001 percent to 5 percent by weight, based on the total weight of the film forming binder. In other embodiments, the catalysts can comprise in the range of from 0.1 to 2 percent by weight, based on the total weight of the film forming binder. In still further embodiments, the coating composition can include in the range of from 0.5 percent to 2 percent by weight, based on the total weight of film forming binder.

One or more organic or aqueous solvents may be included to provide a coating composition having adequate viscosity to allow for spray application, if desired. Suitable solvents can include, for example, aromatic hydrocarbons, such as, for example, petroleum naphtha or xylenes; ketones, such as, for example, methyl amyl ketone, methyl isobutyl ketone, methyl ethyl ketone or acetone; esters, such as, for example, butyl acetate or hexyl acetate; and glycol ether esters, such as, for example, propylene glycol monomethyl ether acetate. The amount of solvent added depends upon the desired solids level as well as the desired amount of volatile organic content (VOC) of the composition. In some embodiments, the coating composition can contain in the range of from 5 to 90 percent by weight of the organic or aqueous solvent. In other embodiments, the coating composition can contain in the range of from 20 to 80 percent by weight of the organic or aqueous solvent. In still further embodiments, the coating composition can contain in the range of from 30 to 70 percent by weight of the organic or aqueous solvent. The percentage by weight of the solvent is based on the total coating composition.

To improve weatherability of a dried and cured layer of the coating composition, one or more light stabilizers can be added. The light stabilizer can be added in an amount in the range of from 0.1 to 5 percent by weight, based on the total weight of the film forming binder. These stabilizers include ultraviolet (UV) light absorbers, screeners, quenchers and hindered amine light stabilizers. Suitable light stabilizers can include, for example, bis(2,2,6,6-tetramethylpiperidinyl)sebacate, bis(N-methyl-2,2,6,6-tetramethylpiperidinyl)sebacate, bis(N-octyloxy-2,2,6,6-tetramethylpiperidynyl)sebacate. Combinations of ultraviolet light absorbers and hindered amine light stabilizers can be included, for example, bis(N-octyloxy-2, 2,6,6-tetramethylpiperidynyl)sebacate and benzenepropanoic acid, 3-(2H-benzotriazol-2-yl)-5-(1,1-dimethylethyl)-4-hydroxy-, C7-9-branched alkyl esters. Another useful combination can include, for example, 2-(3′,5′-bis(1-methyl-1-phenylethyl)-2′-hydroxyphenyl)benzotriazole and decanedioc acid, bis(2,2,6,6, -tetramethyl-4-piperidinyl)ester both supplied by Ciba Specialty Chemicals, Tarrytown, N.Y. under the TINUVIN® light stabilizer trademark.

Also, in the range of from 0.1 to 5 percent by weight, based on the total weight of the film forming binder, of an antioxidant can be added. Suitable antioxidants include, for example, hydroxydodecyl benzophenone, 2,4-dihydroxybenzophenone; triazoles, for example, 2-phenyl-4-(2′-4′-dihydroxybenzoyl)triazole; triazines, for example, 3,5-dialkyl-4-hydroxyphenyl; derivatives of triazines and triazoles, for example, 2-(benzotriazole-2-yl)-4,6-bis(methylethyl-1-phenyl ethyl)phenol, 2-(3-hydroxy-3,5′-di-tert amyl phenyl)benzotriazole, 2-(3′,5′-bis(1,1-dimethylpropyl)-2′-hydroxyphenyl)-2H-benzotriazole, benzenepropanoic acid, 3-(2H-benzotriazol-2-yl)-5-(1,1-dimethylethyl)-4-hydroxy-C7-9-branched alkyl esters and 2-(3′,5′-bis(1-methyl-1-phenylethyl)-2′-hydroxyphenyl)benzotriazole.

Other additives that can be used in a coating composition are known in the art. Suitable additives can include, for example, slip additives; polymerization inhibitors; defoamers; emulsifiers, for example nonionic emulsifiers such as alkoxylated alkanols and polyols, phenols and alkylphenols, or anionic emulsifiers such as alkali metal salts or ammonium salts of alkanecarboxylic acids, alkanesulfonic acids, and sulfo acids of alkoxylated alkanols and polyols, phenols and alkylphenols; wetting agents such as siloxanes, fluorine compounds, carboxylic monoesters, phosphoric esters, polyacrylic acids and their copolymers or polyurethanes; adhesion promoters; leveling agents; film forming auxiliaries such as cellulose ester derivatives; transparent fillers such as nanoparticles based on silicon dioxide, aluminum oxide or zirconium oxide; crosslinked polymeric microgles; silsesquioxanes; inorganic phyllosilicates such as aluminum magnesium silicates, sodium magnesium phyllosilicates and sodium magnesium fluorine lithium phyllosilicates of the montmorillonite type; or synthetic polymers containing ionic and/or associative groups, such as polyvinyl alcohol, poly(meth)acrylamide, poly(meth)acrylic acid, polyvinylpyrrolidone, styrene-maleic anhydride or ethylene-maleic anhydride copolymers and their derivatives, or hydrophobically modified ethoxylated urethanes or polyacrylates; flame retardants and/or flatting agents.

Another embodiment of the present disclosure is a coating composition comprising the polyesterurethane as a crosslinkable component. In some embodiments, the coating composition comprises a crosslinkable component and a crosslinking component wherein the crosslinkable component comprises a polyesterurethane wherein the polyesterurethane is the reaction product of a hydroxyl functional branched polyester prepolymer and an isocyanate functional compound wherein;
(A) the hydroxyl functional branched polyester prepolymer comprises or consists essentially of the reaction product of;
   (I) in the range of from 20 to 80 percent by weight of one or more monofunctional carboxylic acid monomers represented by the formula:

R—COOH
wherein R is an alkyl group of 7 to 17 carbon atoms;
   (II) in the range of from 10 to 40 percent by weight of one or more hydroxyl functional monomers having a hydroxyl functionality of 3 to 10; and
   (III) in the range of fro 10 to 40 percent by weight of one or more polycarboxylic acid monomers; and
(B) the isocyanate functional compound has, on average, at least two isocyanate functional groups per molecule; and

wherein said percentages by weight are based on the total weight of the monomers of the hydroxyl functional branched polyester prepolymer.

In use, when the coating composition is formulated as a two pack coating composition, the crosslinkable and crosslinking components of the coating composition are mixed just prior to use to form a pot mix, which has limited pot life typically ranging from 10 minutes to 24 hours. A layer of pot mix is typically applied to a substrate by conventional techniques, such as spraying, electrostatic spraying, roller coating, dipping or brushing. The applied layer of pot mix can cure under ambient temperature conditions (approximately 19° C. to 29° C.) in the range of 10 minutes to 24 hours, to form a coating on the substrate having the desired coating properties. In another embodiment, the applied layer of pot mix can be cured at elevated temperatures to accelerate the rate of crosslinking. It is understood that the actual curing time depends upon the thickness of the applied layer, the type of crosslinking chemistry being used and on the presence or absence of any suitable drying devices, such as fans that assist in continuously flowing air over the coated substrate to accelerate the dry rate.

When the coating composition is packaged as a one pack composition, a layer of the coating composition is applied in a manner similar to that described earlier. However, since the crosslinking groups in the crosslinking components are blocked, the applied layer of coating composition is typically subjected to bake cure temperatures to unblock the crosslinking groups so that they can crosslink with the crosslinkable groups presented in the crosslinkable component. Typically, the baking step takes place at temperatures in the range of from 60° C. to 200° C., preferably ranging from 80° C. to 160° C., for about 10 to 75 minutes.

Another embodiment of the present disclosure is directed to a substrate coated by a layer of a dried and cured coating composition comprising the disclosed polyesterurethane. The coating composition may be used as a primer coat, a basecoat in a basecoat/clearcoat system, a clearcoat in a basecoat/clearcoat system, or in a topcoat in a single coat or multi-coat system. Suitable substrates can include, for example, automobile bodies, any and all items manufactured and painted by automobile sub-suppliers, frame rails, commercial trucks and truck bodies, including but not limited to beverage bodies, utility bodies, ready mix concrete delivery vehicle bodies, waste hauling vehicle bodies, and fire and emergency vehicle bodies, as well as any potential attachments or components to such truck bodies, buses, farm and construction equipment, truck caps and covers, commercial trailers, consumer trailers, recreational vehicles, including but not limited to, motor homes, campers, conversion vans, vans, pleasure vehicles, pleasure craft snow mobiles, all terrain vehicles, personal watercraft, motorcycles, boats, and aircraft. The substrate can further include industrial and commercial new construction and maintenance thereof; cement and wood floors; leather; walls of commercial and residential structures, such office buildings and homes; amusement park equipment; concrete surfaces, such as parking lots and drive ways; asphalt and concrete road surface, wood substrates, marine surfaces; outdoor structures, such as bridges, towers; coil coating; railroad cars; printed circuit boards; machinery; OEM tools; signage; fiberglass structures; sporting goods; and sporting equipment.

### EXAMPLES

Unless otherwise stated, all ingredients are available from the Aldrich Chemical Company, Milwaukee, Wis.

ASE-60® anionic thickener is available from Dow Chemical, Midland, Mich.

RESIMENE® 4514 is available from

CYMEL® 1168 melamine is available from Cytec Industries,

DESMODUR® BL3575 blocked polyisocyanate is available from Bayer MaterialScience LLC, Pittsburgh, Pa.

FASCAT® 4202 tin catalyst is available from Arkema Inc., Philadelphia, Pa.

SOLVESSO® 100 solvent is available from ExxonMobil, Houston, Tex.

CORMAX® 6 electrocoat is available from E.I. DuPont de Nemours, Wilmington, Del.

The following test procedures were used to test the cured clearcoat compositions.

Testing of the clearcoat resistance to acid etching. An aqueous solution of phosphoric acid having a pH of 1 was prepared. Five drops of the phosphoric acid solution was placed onto each panel and the panel was placed in a 60° C. oven for 30 minutes.

Dry Mar resistance—Panels were coated with a thin layer of Bon Ami abrasive supplied by Faultless Starch/Bon Ami Corporation, Kansas City, Mo. The panels were then tested for mar damage for 10 double rubs against a green felt wrapped fingertip of A.A.T.C.C. Crockmeter (Model CM-1, Atlas Electric Devices Corporation, Chicago, Ill.). The dry mar resistance was recorded as percentage of gloss retention by measuring the 20° gloss of the marred areas versus non-marred areas of the coated panels.

Wet Mar resistance—A similar procedure to that used in Crockmeter-Dry Mar Resistance above was used to test wet mar resistance, except the abrasive medium used was a wet alumina slurry instead of Bon Ami abrasive. The composition of the wet alumina slurry was as follows:

Deionized Water (DI) Water 294 g

ASE-60® Thickener¹ 21 g

AMP-95% (10% solution in DI water)² 25 g

Aluminum oxide (120# grit)³ 7 g
1. Associate thickener supplied by Rohm and Haas Company, Philadelphia, Pa.
2. Supplied by Aldrich Chemicals, Milwaukee, Wis.
3. Abrasive Supplied by MDC Industries, Philadelphia, Pa.

Preparation of Anti-Yellowing Agent

A mixture of 60 parts by weight of deionized water, 20 parts by weight of hypophosphorous acid (30% in water) and 20 parts by weight of 1,6-hexanediol was stirred until well mixed. The anti-yellowing agent was used as is.

### Example 1

### Formation of Branched Polyester Prepolymer

A mixture of 45.04 parts of isononanoic acid, 0.46 parts of anti-yellowing agent, 20.34 parts of hexahydrophthalic anhydride, 29.89 parts of pentaerythritol and 4.25 parts of xylene were stirred at reflux until an acid number of 22 mg KOH/g resin was reached. The resulting mixture was then cooled to 90° C. and was filtered through a 25 μm filter. The resulting polyester had a hydroxyl value of 235 mg KOH/g solid resin, a solids content of 95% and an acid value of 22 mg KOH/g resin and a Gardner number of W—X at 80 percent solids in xylene.

### Example 2

### Formation of Polyesterurethane #1

To a reaction vessel equipped with a dropping funnel and a nitrogen inlet was added 56.46 parts of the branched polyester prepolymer of example 1, 16.09 parts of SOLVESSO© 100 and 17.32 parts of methoxy isopropyl acetate. The mixture was heated to 70° C. 8.36 parts of 1,6-hexamthylene diisocyanate (49.8 percent NCO) was added to the dropping funnel was added over a 25 minute period. 1.76 parts of SOLVESSO© 100 was added to rinse the dropping funnel into the reaction. The mixture was heated to 100° C. and stirred at 100° C. until the residual isocyanate content reached 0%, approximately 3 hours (NCO measurement was carried out by reacting the isocyanate with an excess of dibutylamine followed by titration with HCl 0.5N). The resulting polyesterurethane was cooled to 70° C. and was filtered through a 25 μm filter. The polymer had a hydroxyl value of 100 mg KOH/g solid resin, a solids content of 62, an acid value of 20 mg KOH/g resin, a Gardner color number of 1, a Gardner viscosity of U.

### Example 3

### Formation of Polyesterurethane #2

To a reaction vessel equipped with a dropping funnel and a nitrogen inlet was added 52.64 parts of the branched polyester prepolymer of example 1, 16.09 parts of SOLVESSO© 100 and 17.32 parts of methoxy isopropyl acetate. The mixture was heated to 70° C. 12.18 parts of bis(4 isocyanatecyclohexyl)methane was added to the dropping funnel was added over a 25 minute period. 1.76 parts of SOLVESSO© 100 was added to rinse the dropping funnel into the reaction. The mixture was heated to 100° C. and stirred at 100° C. until the residual isocyanate content reached 0%, approximately 3 hours (NCO measurement was carried out by reacting the isocyanate with an excess of dibutylamine followed by back-titration with HCl 0.5N). The resulting polyesterurethane was cooled to 70° C. and was filtered through a 25 μm filter. The polymer had a hydroxyl value of 100 mg KOH/g solid resin, a solids content of 62, an acid value of 20 mg KOH/g resin, a Gardner color number of 1, a Gardner viscosity of W.

Preparation of Acid Catalyst

A mixture of 38.32 parts by weight of butanol, 46.62 parts of NACURE® XP-221, available from King Industries, Norwalk, Conn., and 15.06 parts by weight of diisopropanolamine was stirred. The mixture was used as is.

Coating Compositions Containing the Polyesterurethanes

TABLE 1

| | Clearcoat | Clearcoat | Comparative |
|---|---|---|---|
| | Example #1 | Example #2 | Clearcoat |
| Ingredient | Weight Percent | | |
| Butanol | 6.98 | 6.98 | 7.44 |
| RESIMENE ® 4514 | 3.42 | 3.24 | 3.64 |
| CYMEL ® 1168 | 5.73 | 5.73 | 6.11 |
| Acid catalyst | 1.05 | 1.05 | 1.12 |
| DESMODUR ® | 14.39 | 14.39 | 15.34 |
| BL3575 | | | |
| Polyesterurethane | 54.11 | 0 | 0 |
| resin #1 | | | |
| Polyesterurethane | 0 | 54.11 | 0 |
| resin #2 | | | |
| Acrylic Resin¹ | 0 | 0 | 51.09 |
| FASCAT ® 4202 | 0.14 | 0.14 | 0.15 |
| SOLVESSO ® 100 | 14.19 | 14.19 | 15.12 |

¹Acrylic Resin is a copolymer comprising 2-Hydroxypropyl acrylate, n-butyl methacrylate, styrene and n-butyl acrylate in a weight ratio of 38/30/15/17.

The ingredients for each example of Table 1 was added to a suitable vessel and mixed. The clearcoat compositions were reduced to a spray viscosity of 34 seconds in a #4 Ford cup. Steel panels were prepared by coating the panels with a layer of CORMAX® 6 electrocoat primer and curing the applied composition. The panel was then coated with a layer of primer composition, Titanium Primer 708A01244, available from DuPont, Wilmington, Del. The primed panel was flashed for 10 minutes at ambient temperature and cured in a drying oven at 140° C. for 30 minutes. The panel was then cooled to ambient temperature. A layer of Ebony Black (Product code 648S42728, available from DuPont, Wilmington, Del.) was applied to the panel and the panel was flashed for 1 minute at ambient temperature. A second layer of Ebony Black was then applied. The panel was flashed at ambient temperature for 3 minutes. One layer of the clearcoat composition were spray applied to each panel followed by a three minute flash time at ambient temperature. A second layer of the clearcoat composition was applied followed by a 5 minute flash at ambient temperature. The panels were then baked for 70 minutes at 140° C. in a vertical position. The panels were removed from the oven and cooled to room temperature and tested for acid etch resistance and Crockmeter dry and wet mar resistance. The results of the test are shown in Table 2.

TABLE 2

| | Clearcoat | Clearcoat | Comparative |
|---|---|---|---|
| | Example #1 | Example #2 | Clearcoat |
| Acid Etch | No visible | No visible | Cloudy appearance and |
| Resistance | effect | effect | loss of clearcoat |
| | | | down to the basecoat. |
| Crockmeter dry | 90% | 87% | 80% |
| mar (percent | | | |
| gloss retention) | | | |
| Crockmeter wet | 87% | 87% | 80% |
| mar (percent | | | |
| gloss retention) | | | |

Clearcoat Examples #1 and #2 showed no damage in the acid etch resistance test. Evaluation of the Comparative Clearcoat Composition showed that the acid had removed a portion of the clearcoat down to the basecoat and that the area where the acid solution was placed had a cloudy appearance. As the mar results show, a clearcoat composition comprising the disclosed polyesterurethane can result in a cured composition having improved etch resistance.

What is claimed is:

1. A polyesterurethane comprising the reaction product of a hydroxyl functional branched polyester prepolymer and an isocyanate functional compound wherein;
(A) said hydroxyl functional branched polyester prepolymer consists essentially of the reaction product of;
(I) in the range of from 20 to 80 percent by weight of one or more monofunctional carboxylic acid monomers represented by the formula:
R—COOH
wherein R is an alkyl group comprising in the range of from 7 to 17 carbon atoms;
(II) in the range of from 10 to 40 percent by weight of one or more hydroxyl functional monomers having a hydroxyl functionality of 3 to 10; and
(III) in the range of from 10 to 40 percent by weight of one or more polycarboxylic acid monomers; and
(B) said isocyanate functional compound has, on average, at least 2 isocyanate functional groups per molecule; and wherein said percent by weight are based on the total weight of the monomers of the hydroxyl functional branched polyester prepolymer.

2. The polyesterurethane of claim 1 wherein said monofunctional carboxylic acid monomer is essentially free from hydroxyl functional groups.

3. The polyesterurethane of claim 1 wherein the monofunctional carboxylic acid monomer is selected from the group consisting of isononanoic acid, oleic acid, decanoic acid, 2-cyclohexyl acetic acid, 2,2-dimethyl pentanoic acid, methyl cyclohexanoic acid, octanoic acid, nonanoic acid and a combination thereof.

4. The polyesterurethane of claim 1 wherein the hydroxyl functional monomer is selected from the group consisting of trimethylol propane, trimethylol ethane, pentaerythritol, glycerol, ditrimethylol propane, dipentaerythritol, tetrakis (2-hydroxyethyl)methane, diglycerol, xylitol, sorbitol, sucrose and a combination thereof.

5. The polyesterurethane of claim 1 wherein the polycarboxylic acid monomer is selected from the group consisting of hexahydrophthalic anhydride, methyl hexahydrophthalic anhydride, alkyl hexahydrophthalic anhydride, maleic acid, fumaric acid, succinic acid, hexahydrophthalic acid, alkyl hexahydrophthalic acid, tetrahydrophthalic acid, alkyl tetrahydrophthalic acid, adipic acid, glutaric acid, malonic acid, azelaic acid, sebacic acid, dodecanoic acid, maleic anhydride, succinic anhydride, tetrahydrophthalic anhydride, methyl tetrahydrophthalic anhydride, alkyl tetrahydrophthalic anhydrides, adipic anhydride, glutaric anhydride and a combination thereof.

6. The polyesterurethane of claim 1 wherein the isocyanate functional compound is a diisocyanate.

7. The polyesterurethane of claim 6 wherein the isocyanate functional compound is chosen from the group selected from 1,2-propane diisocyanate, 1,3-propane diisocyanate, 1,4-butane diisocyanate, 2,3-butane diisocyanate, 1,3-cyclopentane diisocyanate, 1,4-cyclohexane diisocyanate, 1,3-cyclohexane diisocyanate, 1,6-hexamethylene diisocyanate, isophorone diisocyanate, bis(1,4-isocyanatomethyl)cyclohexane, bis(1,3-isocyanatomethyl)cyclohexane and a combination thereof.

8. A coating composition comprising a crosslinkable component and a crosslinking component wherein the crosslinkable component comprises a polyesterurethane wherein the polyesterurethane is the reaction product of a hydroxyl functional branched polyester prepolymer and an isocyanate functional compound wherein;
(A) the hydroxyl functional branched polyester prepolymer comprises or consists essentially of the reaction product of;
(I) in the range of from 20 to 80 percent by weight of one or more monofunctional carboxylic acid monomers represented by the formula:
R—COOH
wherein R is an alkyl group comprising in the range of from 7 to 17 carbon atoms;
(II) in the range of from 10 to 40 percent by weight of one or more hydroxyl functional monomers having a hydroxyl functionality of 3 to 10; and
(III) in the range of from 10 to 40 percent by weight of one or more polycarboxylic acid monomers; and
(B) said isocyanate functional compound has, on average, at least two isocyanate functional groups per molecule; and
wherein said percentages by weight are based on the total weight of the monomers of the hydroxyl functional branched polyester prepolymer.

9. The coating composition of claim 8 wherein said monofunctional carboxylic acid monomer is essentially free from hydroxyl functional groups.

10. The coating composition of claim 8 wherein the monofunctional carboxylic acid monomers is selected from the group consisting of isononanoic acid, oleic acid, decanoic acid, 2-cyclohexyl acetic acid, 2,2-dimethyl pentanoic acid, methyl cyclohexanoic acid, octanoic acid, nonanoic acid and a combination thereof.

11. The coating composition of claim 8 wherein the hydroxyl functional monomer is selected from the group consisting of trimethylol propane, trimethylol ethane, pentaerythritol, glycerol, ditrimethylol propane, dipentaerythritol, tetrakis (2-hydroxyethyl)methane, diglycerol, xylitol, sorbitol, sucrose and a combination thereof.

12. The coating composition of claim 8 wherein the polycarboxylic acid monomer is selected from the group consisting of hexahydrophthalic anhydride, methyl hexahydrophthalic anhydride, alkyl hexahydrophthalic anhydride, maleic acid, fumaric acid, succinic acid, hexahydrophthalic acid, alkyl hexahydrophthalic acid, tetrahydrophthalic acid, alkyl tetrahydrophthalic acid, adipic acid, glutaric acid, malonic acid, azelaic acid, sebacic acid, dodecanoic acid, maleic anhydride, succinic anhydride, tetrahydrophthalic anhydride, methyl tetrahydrophthalic anhydride, alkyl tetrahydrophthalic anhydrides, adipic anhydride, glutaric anhydride and a combination thereof.

13. The coating composition of claim 8 wherein the isocyanate functional compound is a diisocyanate.

14. The coating composition of claim 1 wherein the isocyanate functional compound is 1,2-propane diisocyanate, 1,3-propane diisocyanate, 1,4-butane diisocyanate, 2,3-butane diisocyanate, 1,3-cyclopentane diisocyanate, 1,4-cyclohexane diisocyanate, 1,3-cyclohexane diisocyanate, 1,6-hexamethylene diisocyanate, isophorone diisocyanate, bis(1,4-isocyanatomethyl)cyclohexane, bis(1,3-isocyanatomethyl)cyclohexane and a combination thereof.

15. A substrate coated with a dried and cured layer of a coating composition wherein said coating composition comprises a crosslinkable component and a crosslinking component wherein the crosslinkable component comprises a polyesterurethane wherein the polyesterurethane is the reaction product of a hydroxyl functional branched polyester prepolymer and an isocyanate functional compound wherein;
(A) the hydroxyl functional branched polyester prepolymer comprises or consists essentially of the reaction product of;
(I) in the range of from 20 to 80 percent by weight of one or more monofunctional carboxylic acid monomers represented by the formula:
R—COOH
wherein R is an alkyl group comprising in the range of from 7 to 17 carbon atoms;
(II) in the range of from 10 to 40 percent by weight of one or more hydroxyl functional monomers having a hydroxyl functionality of 3 to 10; and
(III) in the range of from 10 to 40 percent by weight of one or more polycarboxylic acid monomers; and
(B) said isocyanate functional compound has, on average, at least two isocyanate functional groups per molecule; and
wherein said percentages by weight are based on the total weight of the monomers of the hydroxyl functional branched polyester prepolymer.

16. The substrate of claim 15 wherein said monofunctional carboxylic acid monomer is essentially free from hydroxyl functional groups.

17. The substrate of claim 15 wherein the monofunctional carboxylic acid monomer is selected from the group consisting of isononanoic acid, oleic acid, decanoic acid, 2-cyclohexyl acetic acid, 2,2-dimethyl pentanoic acid, methyl cyclohexanoic acid, octanoic acid, nonanoic acid and a combination thereof.

18. The substrate of claim 15 wherein the hydroxyl functional monomer is selected from the group consisting of trimethylol propane, trimethylol ethane, pentaerythritol, glycerol, ditrimethylol propane, dipentaerythritol, tetrakis (2-hydroxyethyl)methane, diglycerol, xylitol, sorbitol, sucrose and a combination thereof.

19. The substrate of claim 15 wherein the polycarboxylic acid monomer is selected from the group consisting of hexahydrophthalic anhydride, methyl hexahydrophthalic anhydride, alkyl hexahydrophthalic anhydride, maleic acid, fumaric acid, succinic acid, hexahydrophthalic acid, alkyl hexahydrophthalic acid, tetrahydrophthalic acid, alkyl tetrahydrophthalic acid, adipic acid, glutaric acid, malonic acid, azelaic acid, sebacic acid, dodecanoic acid, maleic anhydride, succinic anhydride, tetrahydrophthalic anhydride, methyl tetrahydrophthalic anhydride, alkyl tetrahydrophthalic anhydrides, adipic anhydride, glutaric anhydride and a combination thereof.

20. The substrate of claim 15 wherein the isocyanate functional compound is a diisocyanate.

21. The substrate of claim 15 wherein the isocyanate functional compound is 1,2-propane diisocyanate, 1,3-propane diisocyanate, 1,4-butane diisocyanate, 2,3-butane diisocyanate, 1,3-cyclopentane diisocyanate, 1,4-cyclohexane diisocyanate, 1,3-cyclohexane diisocyanate, 1,6-hexamethylene diisocyanate, isophorone diisocyanate, bis(1,4-isocyanatomethyl)cyclohexane, bis(1,3-isocyanatomethyl)cyclohexane and a combination thereof.
